(19) United States
(12) Patent Application Publication
(10) Pub. No.: US 2016/0366940 A1
(43) Pub. Date: Dec. 22, 2016

(54) ELECTRONIC CIGARETTE AND ELECTRONIC CIGARETTE ATOMIZATION CONTROL METHOD

(71) Applicant: KIMREE HI-TECH INC., Tortola (VG)

(72) Inventor: Qiuming Liu, Shenzhen, Guangdong (CN)

(73) Assignee: KIMREE HI-TECH INC., Tortola (VG)

(21) Appl. No.: 15/122,144

(22) PCT Filed: Feb. 28, 2014
(86) PCT No.: PCT/CN2014/072742

§ 371 Date: Aug. 26, 2016

(51) Int. Cl. A24F 47/00; H05B 1/02

(52) U.S. Cl. CPC A24F 47/008; H05B 1/0244; H05B 2203/021

(57) ABSTRACT

The invention is related to an electronic cigarette and an electronic cigarette atomization control method, the electronic cigarette comprising a battery base and an atomization base rotationally connected to the battery base. At least two atomizers used for electrically connecting to the battery base are arranged in the atomization base. The battery base comprises a battery and an elastic electrode assembly used for electrically connecting to at least one atomizer; the at least one atomizer can be electrically connected to the battery via the elastic electrode assembly by rotating the atomization base, so smoke oil in the atomizer connected to the battery can be atomized. Users can inhale different tastes of electronic cigarette smoke in shortest time. The electronic cigarette is easy to manipulate and assembly and is provided with various tastes of electronic cigarette smoke.

### TECHNICAL FIELD

The present invention relates to an electronic commodity, and more particularly relates to an electronic cigarette and an electronic cigarette vaporization control method.

### BACKGROUND

The electronic cigarette is mainly used for the smoking cessation and substituting a cigarette. In the market, the electronic cigarette comprises a battery pole and an atomizer. Two ends of the battery pole are provided with a control panel and a battery which has one anode and one cathode respectively. The control panel is provided with an air flow sensor and a control circuit. The atomizer comprises an electrical heating wire and smoke fluid. When smoking, the control panel controls the battery to supply power for the atomizer, and drives the electrical heating wire to generate heat to produce smoke. However, in prior art, the electronic cigarette only comprises one atomizer and the battery pole which matches with the atomizer, so users can only inhale one taste of electronic cigarette smoke. If users need to inhale different tastes of the electronic cigarette smoke, they must carry a variety of electronic cigarettes equipped with different smoke oil, and it results in a complicated replacement; and every electronic cigarette needs to use its controlling unit to control the atomizer, so a production cost will be increased.

### SUMMARY

A technical problem that the present invention will solve is, aiming at the drawbacks that users can not choose different smoke oil according to their flavor, providing an electronic cigarette and an electronic cigarette atomization control method.

In order to solve the technical problem, a technical proposal which is adopted by the present invention is to provide an electronic cigarette, wherein the electronic cigarette comprises a battery base and an atomization base rotationally connected to the battery base; at least two atomizers used for electrically connecting to the battery base are arranged in the atomization base; the battery base comprises a battery and an elastic electrode assembly used for electrically connecting to at least one atomizer; the at least one atomizer can be electrically connected to the battery via the elastic electrode assembly by rotating the atomization base, so smoke oil in the atomizer connected to the battery can be atomized.

In the electronic cigarette provided in the present invention, each of the atomizers comprises a first electrode and a second electrode which are used for electrically connecting to the elastic electrode assembly; the elastic electrode assembly comprises at least one first elastic electrode and a second elastic electrode which are used for electrically connecting to the battery; by rotating the atomization base, the first electrode of the at least one of the atomizers is electrically connected to the first elastic electrode, and the second electrode is electrically connected to the second elastic electrode.

In the electronic cigarette provided in the present invention, the first elastic electrode comprises a first elastic piece and a third electrode which is connected to the first elastic piece and is used for electrically connecting to the first electrode.

In the electronic cigarette provided in the present invention, the second elastic electrode comprises a second elastic piece and a fourth electrode which is connected to the second elastic piece and is used for electrically connecting to the second electrode.

In the electronic cigarette provided in the present invention, the elastic electrode assembly further comprises an elastic insulation piece, the elastic insulation piece is used for abutting the atomizer.

In the electronic cigarette provided in the present invention, the elastic insulation piece comprises a third elastic piece and an insulation piece which is connected to the third elastic piece and is used for abutting the atomizer.

In the electronic cigarette provided in the present invention, the battery base further comprises a fixed base used for fixing the elastic electrode assembly, the fixed base is provided with a first connecting hole, a second connecting hole and a third connecting hole which match with the first elastic electrode, the second elastic electrode and the elastic insulation piece respectively.

In the electronic cigarette provided in the present invention, the atomization base further comprises a first base body used for driving each of the atomizers to rotate, a connecting board which is electrically connected to the second electrode of each of the atomizers, the connecting board and the elastic electrode assembly are electrically connected.

In the electronic cigarette provided in the present invention, the connecting board is provided with at least two through holes which match with the second electrode of each of the atomizers, the first electrode of the atomizers, the first electrode of the atomizers is through the through hole and abuts the first elastic electrode or the elastic insulation piece.

In the electronic cigarette provided in the present invention, an end face of the connecting board close to the battery base is provided with at least one groove which matches with the second elastic electrode, the groove can position the atomization base.

In the electronic cigarette provided in the present invention, the battery base further comprises a second base body, the second base body is circumferentially provided with a first air hole used for being flowed by the air; the first elastic electrode is provided with a second air hole which is communicated with the first air hole and the atomizers.

In the electronic cigarette provided in the present invention, the second base body is provided with a controlling unit used for controlling the atomizers and an air flow sensor which is electrically connected to the controlling unit; the air flow sensor is used for detecting an air flow signal and sending a trigger signal to the controlling unit, the controlling unit is used for controlling the atomizers to atomize the smoke oil according to the trigger signal.

In the electronic cigarette provided in the present invention, an end of the atomization base which is opposite to the battery base is a suction nozzle end; a suction tube is detachably connected to the suction nozzle end.

The present invention further provides an electronic cigarette atomization control method, used for controlling at least two atomizers connected to a battery base, wherein the method comprises following steps:

S1. Rotate an atomization base to electrically connect the at least one of the atomizers to a battery in the battery base via an elastic electrode assembly in the battery base;

S2. An air flow sensor detects an air flow signal and sends a trigger signal to a controlling unit;

S3. The controlling unit receives the trigger signal to control the atomizers to atomize smoke oil.

The beneficial effects of implementing the present invention compared to prior art are:

The present invention provides an electronic cigarette that can meet the users' needs for inhaling different tastes of electronic cigarette smoke in shortest time. The electronic cigarette comprises a battery base and an atomization base rotationally connected to the battery base. At least two atomizers are arranged in the atomization base. The atomizers can be chosen by rotating the atomization base, and then the chosen atomizer can be electrically connected to the battery. The users can rotate the atomization base to inhale one taste of electronic cigarette smoke or mixed tastes of electronic cigarette smoke. The electronic cigarette of the present invention is easy to manipulate and assembly and is provided with various tastes of electronic cigarette smoke.

### BRIEF DESCRIPTION OF THE DRAWINGS

The invention will be further described with reference to the accompanying drawings and embodiments in the following.

FIG. 1 is a structure schematic diagram of the electronic cigarette provided in a first preferred embodiment of the present invention.

FIG. 2 is an exploded view of the electronic cigarette shown in FIG. 1.

FIG. 3 is a perspective view of the electronic cigarette shown in FIG. 1.

FIG. 4 is a structure schematic diagram of the battery base of the electronic cigarette shown in FIG. 1.

FIG. 5 is a structure schematic diagram of the atomization base of the electronic cigarette shown in FIG. 1.

FIG. 6 is a structure schematic diagram of the electronic cigarette provided in a second preferred embodiment of the present invention.

FIG. 7 is a structure schematic diagram of the battery base of the electronic cigarette shown in FIG. 6.

### DETAILED DESCRIPTION OF THE PREFERRED EMBODIMENT

Aiming at the drawbacks that the electronic cigarette in prior art only comprises one atomizer and a battery pole which matches with the atomizer, so users can only inhale one taste of electronic cigarette smoke in one time, the present invention provides an electronic cigarette that can meet the users' needs for inhaling different tastes of electronic cigarette smoke in shortest time. The electronic cigarette comprises a battery base and an atomization base which is rotationally connected to the battery base. At least two atomizers are arranged in the atomization base. The atomizers can be chosen by rotating the atomization base, and then the chosen atomizer can be electrically connected to the battery. The users can rotate the atomization base to inhale one taste of electronic cigarette smoke or mixed tastes of electronic cigarette smoke. The electronic cigarette of the present invention is easy to manipulate, simple to assembly and has a good selectivity. The present invention solves the problem that users must carry a variety of electronic cigarettes equipped with different smoke oil if they need to inhale different tastes of electronic cigarette smoke.

In order to better understand the technical features, purpose and effect of the present invention, the preferred embodiments will be detailedly descried in the following. It can be understood that the embodiments are used for explaining the present invention and the present invention is not limited by these embodiments.

FIG. 1 shows an electronic cigarette provided in a first preferred embodiment of the present invention. The electronic cigarette comprises a battery base 2 and an atomization base 1 rotationally connected to the battery base 2; at least two atomizers 12 used for electrically connecting to the battery base 2 are arranged in the atomization base 1; each of the atomizers 12 is provided with a taste of smoke oil; it can be understood that tastes of smoke oil can be the same in two or more atomizers 12, there are not limited here. The battery base 2 comprises a battery 20 and an elastic electrode assembly 21 which is shown in FIG. 4 and used for electrically connecting to at least one of the atomizers 12; the at least one of the atomizers 12 can be electrically connected to the battery 20 via the elastic electrode assembly 21 by rotating the atomization base 1, so smoke oil in the atomizers 12 which is connected to the battery 20 can be atomized.

Further, as shown in FIG. 1, each of the atomizers 12 comprises a first electrode 13 and a second electrode 14 which are used for electrically connecting to the battery base 2; the elastic electrode assembly 21 of the battery case 2 comprises at least one first elastic electrode 22 and a second elastic electrode 23 which are used for electrically connecting to the battery 20; by rotating the atomization base 1, the first electrode 13 of the at least one of the atomizers is electrically connected to the first elastic electrode 22, and the second electrode 14 is electrically connected to the second elastic electrode 23.

Thus, users only need to rotate the atomization base 1 to electrically connect the atomizers 12 that need to be used to the elastic electrode assembly 21, and then the one of the atomizers 12 which is chosen by the users is electrically connected to the battery 20 via the elastic electrode assembly 21. The whole process is easy to manipulate, simple to assembly, and can satisfy users' need of switching any taste of electronic cigarette smoke.

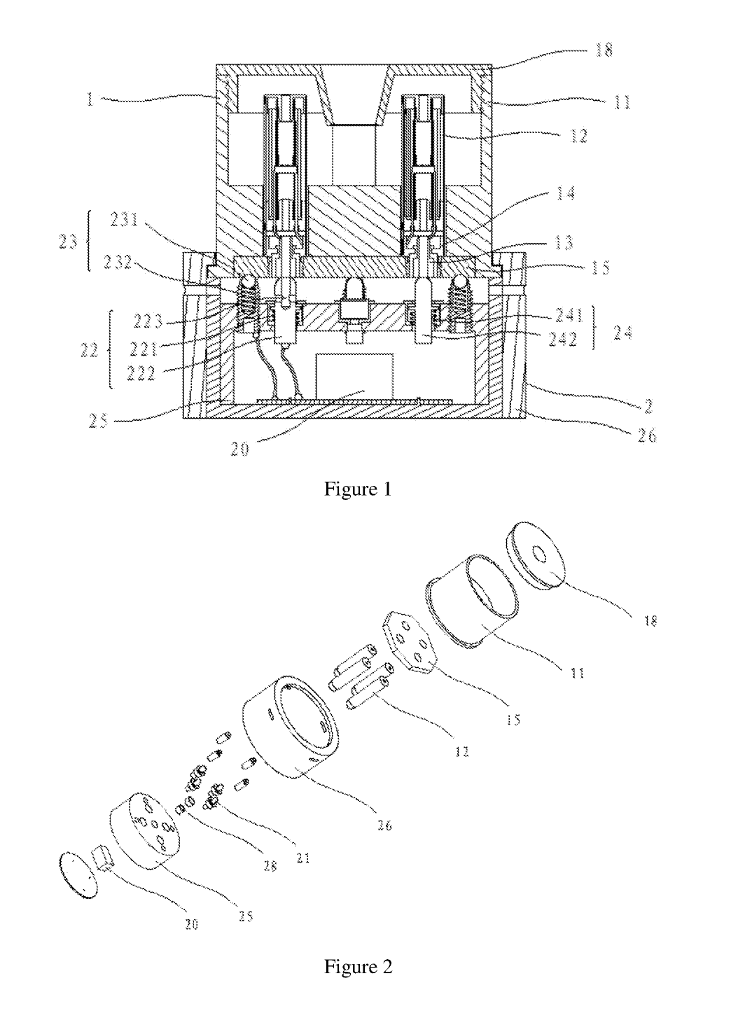

As shown in FIG. 2 and in combination with FIG. 1, the battery base 2 mainly comprises the battery 20, the elastic electrode assembly 21, a fixed base 25, a second base body 26, a controlling unit 28 and the air flow sensor (not shown in the figures). The second base body 26 is approximately a hollow cylindrical structure. The battery 20, the elastic electrode assembly 21, the fixed base 25, the controlling unit 28 and the air flow sensor are all fixed inside the second base body 26. Wherein, the elastic electrode assembly 21 comprises a first elastic electrode 22, a second elastic electrode 23 and an elastic insulation piece 24.

The first elastic electrode 22 is mainly used for abutting against and electrically connecting to the first electrode 13 of the one of the atomizers 12 which is chosen by the users. Specifically, the first elastic electrode 22 comprises a first elastic piece 221 and a third electrode 222 which is connected to the first elastic piece 221. Wherein, the first elastic piece 221 can be an elastic slice or a spring. In this embodiment, the first elastic piece 221 is a spring structure, the third electrode 222 is a conductive cylindrical structure, and the third electrode 222 is arranged inside the first elastic piece 221; an annular bulge (not labeled in figures) is formed by extending from a circumference of the third electrode 222 to a direction which is opposite to a central axis of the third electrode 222. A bottom of the annular bulge is used for abutting against the spring to avoid the spring to be separated from the third electrode 222.

The second elastic electrode 23 is mainly used for electrically connecting to the second electrode 14 of the one of the atomizers 12 which is chosen by the users and positioning the atomization base 1. The second elastic electrode 23 comprises a second elastic piece 231 and a fourth electrode 232 which is connected to the second elastic piece 231. Wherein, the second elastic electrode 231 can be an elastic slice or a spring. In this embodiment, the second elastic piece 231 is a spring structure, the third electrode 222 is a conductive spheriform structure, and the fourth electrode 232 is fixedly connected to a side of the second elastic piece 231 which is close to the atomizers 12.

As the second elastic electrode 23 needs to match with the atomization base 1 to position the atomization base 1, positioning effect of the second elastic electrode 23 will be specifically described in the following part which is used to describe the atomization base 1.

The elastic insulation piece 24 is mainly used for abutting the first electrode 13 of the one of the atomizers 12 which is chosen by the users. The elastic insulation piece 24 comprises a third elastic piece 241 and an insulation piece 242 which is connected to the third elastic piece 241. Wherein, the third elastic piece 241 can be an elastic slice or a spring. In this embodiment, the third elastic piece 241 is a spring structure, the insulation piece 242 is a cylindrical structure, and the insulation piece 242 is arranged inside the third elastic piece 241. An annular bulge (not labeled in figures) is formed by extending from a circumference of the insulation piece 242 to a direction which is opposite to a central axis of insulation piece 242. A bottom of the annular bulge is used for abutting the spring.

As the elastic electrode assembly 21 is mainly used for electrically connecting to the atomizers 12, connecting the third electrode 222, the fourth electrode 232 and the insulation piece 242 to the elastic slice or the spring respectively can increase a connecting stability between the elastic electrode assembly 21 and the atomization base 1. A poor connection between the atomizers 12 and the elastic electrode assembly 21 that may lead the electronic cigarette not to work can be avoided.

Specifically, the fixed base 25 is approximately a cylindrical structure and is arranged inside the second base body 26. The fixed base 25 is mainly used for fixing the elastic electrode assembly 21. An inside of the fixed base 25 is provided with a container that contains the battery 20, the controlling unit 28 and the air flow sensor. Further, an end surface of the fixed base 25 which is close to the atomization base 1 is provided with a first connecting hole, a second connecting hole and a third connecting hole which are all not labeled in figures and are matched with the first elastic electrode 22, the second elastic electrode 23 and the elastic insulation piece 24 respectively. Wherein, the first elastic electrode 22 is fixed inside the first connecting hole, the second elastic electrode 23 is fixed inside the second connecting hole, and the elastic insulation piece 24 is fixed inside the third connecting hole.

In this embodiment, in order to better fix the elastic electrode assembly 21, the first elastic electrode 22 can be covered with a hollow cylindrical structure (not labeled in figures), and then the hollow cylindrical structure is fixed inside the first connecting hole. Specifically, the first elastic piece 221 is accommodated in the hollow cylindrical structure, and the third electrode 222 is arranged inside the first elastic piece 221, and both ends of the third electrode 222 extrude the hollow cylindrical structure to enable the third electrode 222 can elastically move along an axis of the hollow cylindrical structure, so the atomizers 12 can better abut against the first electrode 13. Besides, the upper end of the upper annular bulge of the third electrode 222 is used for abutting the upper wall of the hollow cylindrical structure. The lower end of the upper annular bulge of the third electrode 222 abuts the first elastic piece 221. By arranging the annular bulge, a movement of the first elastic electrode 22 along an axis of the battery base 2 can be limited to achieve a better fixing of the first elastic electrode 22, and the connection stability between the first elastic electrode 22 and the atomizers 12 can be ensured.

Further, a conductive threaded fastener (not labeled in figures) can be fixed in the second connecting hole, and a side of the threaded fastener which is close to the atomization base 1 is provided with a clamping groove (not labeled in figures). By fixing the second elastic electrode 23 in the clamping groove, the second elastic electrode 23 can move up and down along the axis of the battery base 2. As the structure of the elastic insulation piece 24 is similar as that of the first elastic electrode 22, the details will not be described in here.

In combination with FIG. 4, one first elastic electrode 22, four second elastic electrodes 23, and three elastic insulation pieces 24 are defined in this embodiment. Wherein, the first elastic electrodes 22 and the elastic insulation pieces 24 are uniformly distributed on the fixed base 25 along a rotating path of the atomizers 12, and four of the second elastic electrodes 23 encircle the first elastic electrode 22 and the elastic insulation pieces 24, respectively.

Specifically, the controlling unit 28 is mainly used for controlling the one of the atomizers 12 which is chosen by the users to work and is electrically connected to the battery 20. In this embodiment, in combination with FIG. 2, the controlling unit 28 is arranged on the fixed base 25 and abuts the atomization base 1. The air flow sensor is electrically connected to the controlling unit 28. The air flow sensor is used for detecting an air flow signal and sending a trigger signal to the controlling unit 28, the controlling unit 28 is used for controlling the one of the atomizers 12 which is chosen by the users to atomize the smoke oil according to the trigger signal. The controlling unit 28 further comprises a microprocessor and a transistor. The transistor can be a triode or a field-effect transistor. A connection and disconnection between electrodes of the battery and the electrical heating wire in the atomizers can be realized by controlling a conduction and dis conduction of the transistor. As the structures of the air flow sensor and the controlling unit 28 are prior arts, the details will not be described. It can be understood that the controlling unit 28 can be replaced to a key switch.

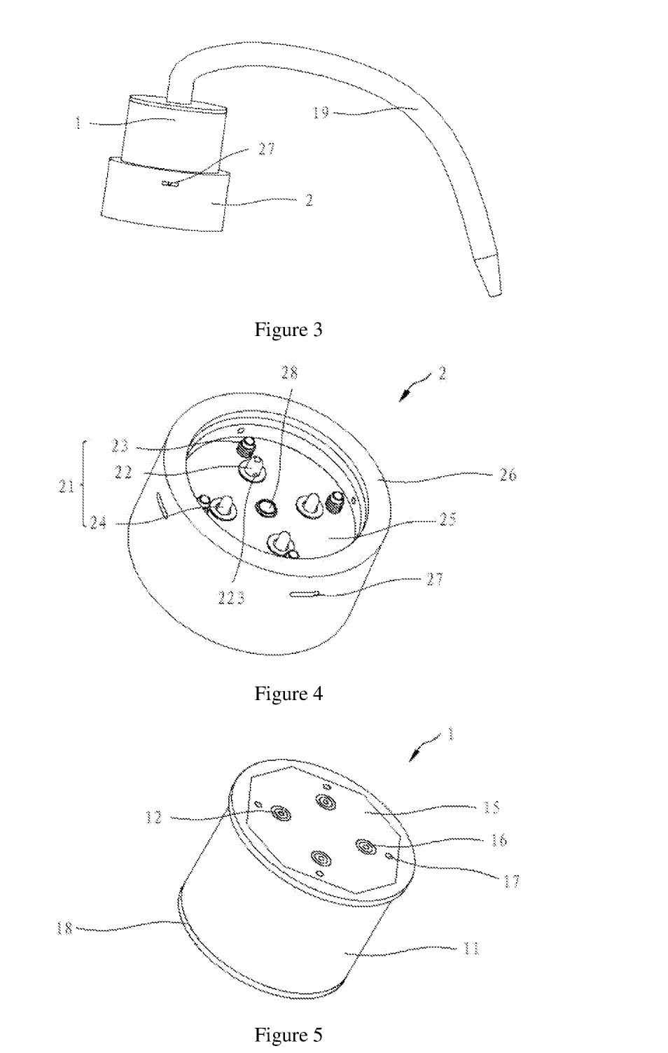

As shown in FIG. 3 and in combination with FIG. 1, the second base body 26 is circumferentially provided with a first air hole 27 which is used for being flowed by the air, the first air hole 27 is an air inlet; the first elastic electrode 22 is provided with a second air hole 223 which is communicated with the first air hole 27 and the atomizers 12. An air channel (not shown in figures) in the first air hole 27, the second air hole 223 and the atomizers 12 constitutes a smoke channel.

As shown in FIG. 5 and in combination with FIG. 1, the atomization base 1 mainly comprises a first base body 11, the atomizers 12 and a connecting board 15. Wherein, the first base body 11 is approximately a cylindrical structure, the connecting board 15 is arranged on an end surface of the first base body 11 which is toward the battery base 2, and the atomizers 12 is fixed in the first base body 11 and is fixedly connected to the connecting board 15. The first base body 11 is mainly used for driving the atomizers 12 to rotate. The atomizers 12 and the connecting board 15 can rotate by rotating the first base body 11. In this embodiment, number of the atomizers 12 is four. As structures of the atomizers 12 is a prior art, details will not be described.

As shown in FIG. 5, the connecting board 15 is made of conductive materials, and is mainly used for abutting the elastic electrode assembly 21 and conducting. Specifically, the connecting board 15 is provided with four through holes 16 which match with the second electrode 14 (shown in combination with FIG. 1) of the atomizers 12. The atomizers 12 are fixed on the connecting board 15 via the through holes 16. By rotating the atomization base 1, the one of the atomizers 12 which is chosen by the users is electrically connected to the first elastic electrode 22 via the through holes 16, and the others of the atomizers 12 which are not chosen by the users abuts the elastic insulation piece 24 via the through holes 16.

An end surface of the connecting board 15 close to the battery base 2 is provided with at least one groove 17 which matches with the second elastic electrode 23. When the first electrode 13 of the one of the atomizers 12 which is chosen by the users is electrically connected to the first elastic electrode 22, the second elastic electrode 23 abuts the groove 17. So the groove 17 and the second elastic electrode 23 are matched with each other to position the atomization base 1 together.

Further, an end of the atomization base 1 which is opposite to the battery base 2 is a suction nozzle end 18; a suction tube 19 (shown in FIG. 3) is detachably connected to the suction nozzle end 18. The first air hole 27 and the second air hole 223 of the battery base 2, the air flow channel in the atomizers 12 and the suction nozzle end 18 constitute an air flow passage of the present invention.

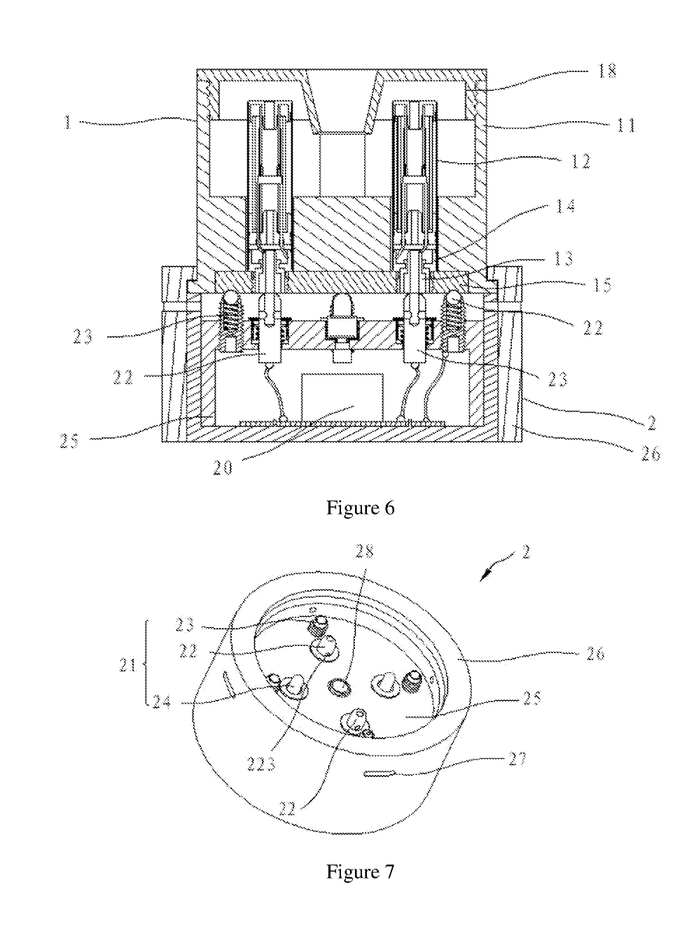

FIG. 6 is a structure schematic diagram of the electronic cigarette provided in a second preferred embodiment of the present invention. A difference with the first embodiment is the elastic electrode assembly 21 comprises two first elastic electrodes 22. Users can inhale two different tastes of electronic cigarette smoke at a time by rotating.

As shown in FIG. 7, two first elastic electrodes 22, four second elastic electrodes 23 and two elastic insulation pieces 24 are defined in this embodiment. Wherein, the first elastic electrodes 22 and the elastic insulation pieces 24 are uniformly distributed on the fixed base 25 along a rotating path of the atomizers 12, and four of the second elastic electrodes 23 encircle the first elastic electrode 22 and the elastic insulation pieces 24 respectively.

The present invention further provides an electronic cigarette atomization control method, the method is used for controlling at least two atomizers 12 connected to a battery base 2. The method comprises following steps:

S1. rotate an atomization base 1 to electrically connect at least one of the atomizers 12 to a battery 20 in the battery base 2 via an elastic electrode assembly 21 in the battery base 2;

S2. An air flow sensor detects an air flow signal and sends a trigger signal to a controlling unit 28;

S3. The controlling unit 28 receives the trigger signal and controls the at least one of the atomizers 12 to atomize smoke oil.

Specifically, the elastic electrode assembly 21 comprises at least one first elastic electrode 22 connected to the one of the atomizers 12 which is chosen by the users. When rotating the atomization base 1, one or more atomizers with different tastes can be activated. Users can inhale mixed tastes of electronic cigarette smoke. It is interesting and meets the users' individual needs.

In conclusion, the present invention provides an electronic cigarette that can meet the users' needs for inhaling different tastes of electronic cigarette smoke in shortest time. The electronic cigarette comprises a battery base and an atomization base rotationally connected to the battery base. At least two atomizers are arranged in the atomization base. The atomizers can be chosen by rotating the atomization base, and then the chosen atomizer can be electrically connected to the battery. The users can rotate the atomization base to inhale one taste of electronic cigarette smoke or mixed tastes of electronic cigarette smoke. The electronic cigarette of the present invention is easy to manipulate and assembly and has a good selectivity. The present invention solves the problem that users must carry a variety of electronic cigarettes equipped with different smoke oil if they need to inhale different tastes of electronic cigarette smoke.

Combining with the accompanying drawings, embodiments of the present invention are described. However, the present invention is not limited by the above embodiments, which means that the above specific embodiments are only schematic, rather than restrictive. It should be understood that, in the inspiration of the present invention, those skilled in the art who appreciate and realize all or part of the process in above embodiments may make many modifications or alternatives, without going beyond the purpose and the scope the claims intend to protect of the present application. All these belong to the protection of the present invention.

What is claimed is:

1. An electronic cigarette, comprising a battery base (2) and an atomization base (1) rotationally connected to the battery base (2); at least two atomizers (12) used for electrically connecting to the battery base (2) are arranged in the atomization base (1); wherein the battery base (2) comprises a battery (20) and an elastic electrode assembly (21) used for electrically connecting to at least one of the atomizers (12); the at least one of atomizers (12) can be electrically connected to the battery (20) via the elastic electrode assembly (21) by rotating the atomization base (1), so smoke oil in the at least one of the atomizers (12) which is connected to the battery (20) can be atomized.

2. The electronic cigarette according to claim 1, wherein each of the atomizers (12) comprises a first electrode (13) and a second electrode (14) which are used for electrically connecting to the elastic electrode assembly (21); the elastic electrode assembly (21) comprises at least one first elastic electrode (22) and a second elastic electrode (23) which are used for electrically connecting to the battery (20); by rotating the atomization base (1), the first electrode (13) of the at least one of the atomizers is electrically connected to the first elastic electrode (22), and the second electrode (14) is electrically connected to the second elastic electrode (23).

3. The electronic cigarette according to claim 2, wherein the first elastic electrode (22) comprises a first elastic piece (221) and a third electrode (222) which is connected to the first elastic piece (221) and is used for electrically connecting to the first electrode (13).

4. The electronic cigarette according to claim 2, wherein the second elastic electrode (23) comprises a second elastic piece (231) and a fourth electrode (232) which is connected to the second elastic piece (231) and is used for electrically connecting to the second electrode (14).

5. The electronic cigarette according to claim 2, wherein the elastic electrode assembly (21) further comprises an elastic insulation piece (24), the elastic insulation piece (24) is used for abutting the atomizers (12).

6. The electronic cigarette according to claim 5, wherein the elastic insulation piece (24) comprises a third elastic piece (241) and an insulation piece (242) which is connected to the third elastic piece (241) and is used for abutting the atomizers (12).

7. The electronic cigarette according to claim 5, wherein the battery base (2) further comprises a fixed base (25) used for fixing the elastic electrode assembly (21), the fixed base (25) is provided with a first connecting hole, a second connecting hole and a third connecting hole which are matched with the first elastic electrode (22), the second elastic electrode (23) and the elastic insulation piece (24) respectively.

8. The electronic cigarette according to claim 2, wherein the atomization base (1) further comprises a first base body (11) used for driving each of the atomizers (12) to rotate, and a connecting board (15) which is electrically connected to the second electrode (14) of each of the atomizers (12), the connecting board (15) and the elastic electrode assembly (21) are electrically connected.

9. The electronic cigarette according to claim 8, wherein the connecting board (15) is provided with at least two through holes (16) which match with the second electrode (14) of each of the atomizers (12), the first electrode (13) of the atomizers (12) is passed through the through holes (16) and abuts the first elastic electrode (22) and/or the elastic insulation piece (24).

10. The electronic cigarette according to claim 8, wherein an end surface of the connecting board (15) close to the battery base (2) is provided with at least one groove (17) which matches with the second elastic electrode (23), the groove (17) can position the atomization base (1).

11. The electronic cigarette according to claim 2, wherein the battery base (2) further comprises a second base body (26), the second base body (26) is circumferentially provided with a first air hole (27) used for being flowed by the air; the first elastic electrode (22) is provided with a second air hole (223) which is communicated with the first air hole (27) and the atomizers (12).

12. The electronic cigarette according to claim 11, wherein an inside of the second base body (26) is provided with a controlling unit (28) used for controlling the atomizers (12) and an air flow sensor which is electrically connected to the controlling unit (28); the air flow sensor is used for detecting an air flow signal and sending a trigger signal to the controlling unit (28), the controlling unit (28) is used for controlling the atomizers (12) to atomize the smoke oil according to the trigger signal.

13. The electronic cigarette according to claim 1, wherein an end of the atomization base (1) which is opposite to the battery base (2) is a suction nozzle end (18); a suction tube (19) is detachably connected to the suction nozzle end (18).

14. An electronic cigarette atomization control method, used for controlling at least two atomizers (12) connected to a battery base (2), wherein the method comprises following steps:
S1. Rotate an atomization base (1) to electrically connect the at least one of the atomizers (12) to a battery (20) in the battery base (2) via an elastic electrode assembly (21) in the battery base (2);
S2. An air flow sensor detects an air flow signal and sends a trigger signal to a controlling unit (28);
S3. The controlling unit (28) receives the trigger signal and controls the at least one of the atomizers (12) to atomize smoke oil.
